(19) United States
(12) Patent Application Publication
(10) Pub. No.: US 2008/0123375 A1
(43) Pub. Date: May 29, 2008

(54) Multi-Mode Power Converter

(75) Inventor: Benedict J. Beardsley, West Simsbury, CT (US)

Correspondence Address: CANTOR COLBURN, LLP, 20 Church Street, 22nd Floor, Hartford, CT, 06103, US

(73) Assignee: ITT MANUFACTURING ENTERPRISES, INC., Wilmington, DE (US)

(21) Appl. No.: 11/564,360

(22) Filed: Nov. 29, 2006

(51) Int. Cl. H02M 7/44

(52) U.S. Cl. 363/71

(57) ABSTRACT

A power converter including a DC input; an AC input; a conditioning module coupled to the DC input; a first inverter coupled to the conditioning module, the first inverter providing a first AC voltage to a first AC output; a second inverter coupled to the conditioning module, the second inverter providing a second AC voltage to a second AC output; a converter coupled to the conditioning module, the converter providing a DC voltage to a first DC output; and a second DC output coupled to the conditioning module.

### BACKGROUND OF THE INVENTION

Embodiments relate generally to power supplies, and in particular to a multi-mode power converter.

Power converters are used to convert electrical power from one mode to another. There are a variety of power converters that convert AC to DC voltage, DC to AC voltage, etc. There is a drawback with existing power converters in that the types of power conversion are not conducive to certain applications. For example, in the military field, existing power converters do not provide for operation with vehicle DC voltages, nor do existing power converters generate a DC output commensurate with vehicle DC voltages. This results in difficulties in training, testing and maintaining components that run on vehicle power (e.g., 24V DC). For example, to train personnel in the operation of certain vehicle equipment, the vehicle must be available to power the equipment. This limits the locations for training (i.e., training is limited to locations where vehicles have access) and also puts unneeded burden on vehicles by unnecessarily running the vehicle and diverting the vehicle from other tasks.

There is a need in the art for a power converter that accepts a variety of power sources and generates a variety of output voltages, including DC vehicle power.

### BRIEF SUMMARY OF THE INVENTION

The shortcomings of the prior art are overcome and additional advantages are provided through the provision of a power converter.

An embodiment of the invention is a power converter including a DC input; an AC input; a conditioning module coupled to the DC input; a first inverter coupled to the conditioning module, the first inverter providing a first AC voltage to a first AC output; a second inverter coupled to the conditioning module, the second inverter providing a second AC voltage to a second AC output; a converter coupled to the conditioning module, the converter providing a DC voltage to a first DC output; and a second DC output coupled to the conditioning module.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a power converter in an embodiment of the invention.

### DETAILED DESCRIPTION

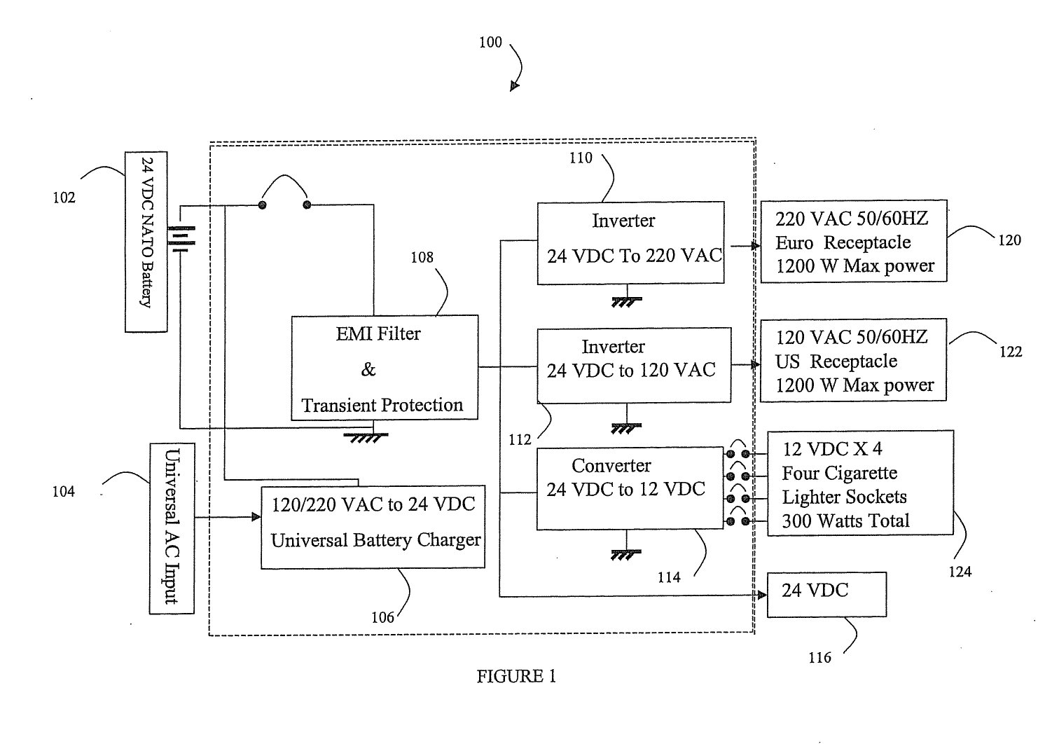

FIG. 1 is a block diagram of a power converter 100 in an embodiment of the invention. Power converter 100 includes a DC input 102, which may be coupled to vehicle battery NATO battery as shown in FIG. 1. It is understood that other DC sources may be coupled at the DC input 102. A universal AC input 104 provides a connection for either 120 VAC or 220 VAC power sources. A universal AC to DC converter 106 converts either 120 or 220 VAC to 24 VDC and provides a trickle charge to the positive DC input 102. The AC to DC converter 106 serves as a universal battery charger for a vehicle battery coupled to DC input 102.

The DC input 102 is coupled to conditioning module 108 that provides EMI filtering and transient protection. The EMI filtering and transient protection conditions the DC power to remove spurious signals that may be induced by other vehicle systems (e.g., induced voltage from spark plug wires).

The 24 VDC output from the conditioning module 108 is provided to inverters 110 and 112, converter 114 and DC output 116. Inverter 110 converts the 24 VDC to 220VAC and provides the 220 VAC to first AC output 120. First AC output 120 includes a receptacle for a European type AC adapter, and provides 220 VAC at 50/60 HZ with a maximum power of 1200 watts. It is understood that different types of AC receptacles may be used, and embodiments are not limited to European type connections.

Inverter 112 converts the 24 VDC to 120VAC and provides the 120 VAC to second AC output 122. Second AC output 122 includes a receptacle for a US type AC adapter, and provides 120 VAC at 50/60 HZ with a maximum power of 1200 watts. It is understood that different types of AC receptacles may be used, and embodiments are not limited to US type connections. Inverters 110 and 112 provide power for low power A/C (110V or 220V) items (laptop computers, cell phones, etc;) and small power tools from the vehicle onboard power system through DC input 102.

Converter 114 converts the 24 VDC to 12 VDC and provides the 12 VDC to first DC output 124. First DC output 124 includes four 12 VDC sockets (e.g., cigarette lighter sockets), and provides 12 VDC with a maximum power of 300 watts. It is understood that different types of DC receptacles may be used, and embodiments are not limited to cigarette lighter sockets. DC output 124 allows operation of standard automotive (12 VDC) accessories, such as spotlights, without requiring the vehicle to be present.

The second DC output 116 provides a connection point for the conditioned 24 VDC power from conditioning module 118. Second DC output 116 may be used to power components typically used with a vehicle on the vehicle power (e.g., 24 VDC battery). This second DC output 116 allows personnel to operate components away from a vehicle for the purposes of training, maintenance, etc. This eliminates the need for a vehicle to be present when using such devices.

The power converter 100 is a stand-alone unit that permits connection to available external power sources (110V or 220V AC) to operate vehicle mounted and other AC/DC equipment from the external power source. This reduces the wear on vehicle engine and batteries and reduces fuel consumption. The power converter can also trickle charge vehicle batteries. When connected to the vehicle battery, low power AC and DC devices can be operated from the appropriate AC and DC outputs.

While the invention has been described with reference to exemplary embodiments, it will be understood by those skilled in the art that various changes may be made and equivalents may be substituted for elements thereof without departing from the essential scope thereof. Therefore, it is intended that the invention not be limited to the particular embodiments disclosed for carrying out the invention, but that the invention will include all embodiments falling within the scope of the appended claims.

What is claimed is:

1. A power converter comprising:
a DC input;
an AC input;
a conditioning module coupled to the DC input;
a first inverter coupled to the conditioning module, the first inverter providing a first AC voltage to a first AC output;
a second inverter coupled to the conditioning module, the second inverter providing a second AC voltage to a second AC output;
a converter coupled to the conditioning module, the converter providing a DC voltage to a first DC output; and
a second DC output coupled to the conditioning module.

2. The power converter of claim 1 further comprising:
an AC to DC converter coupled to the AC input, the AC to DC converter generating a trickle charge DC output coupled to the DC input.

3. The power converter of claim 1 wherein:
the conditioning module provides EMI filtering and transient protection for voltage from the DC input.

4. The power converter of claim 1 wherein:
the DC input is 24 VDC and the first inverter generates 220 VAC from the 24 VDC.

5. The power converter of claim 4 wherein:
the first AC output includes a receptacle for a European type AC adapter.

6. The power converter of claim 1 wherein:
the DC input is 24 VDC and the second inverter generates 120 VAC from the 24 VDC.

7. The power converter of claim 6 wherein:
the second AC output includes a receptacle for a US type AC adapter.

8. The power converter of claim 1 wherein:
the DC input is 24 VDC and the converter generates 12 VAC from the 24 VDC.

9. The power converter of claim 8 wherein:
the first DC output includes a plurality of 12 VDC receptacles.
